(19) United States
(12) Patent Application Publication
(10) Pub. No.: US 2009/0093558 A1
(43) Pub. Date: Apr. 9, 2009

(54) MOBILE EXPANDED POLYMER PROCESSING SYSTEMS AND METHODS

(75) Inventors: John K. Madish, Negley, OH (US); Michael T. Williams, Beaver Falls, PA (US); Shawn P. Jarvie, Monaca, PA (US); Michael R. Kelley, Butler, PA (US); Justin D. Rubb, Coraopolis, PA (US)

Correspondence Address: NOVA Chemicals Inc., Westpointe Center, 1550 Coraopolis Heights Road, Moon Township, PA, 15108, US

(73) Assignee: NOVA Chemicals Inc., Moon Township, PA (US)

(21) Appl. No.: 11/867,122

(22) Filed: Oct. 4, 2007

(51) Int. Cl. C08J 9/228; B01J 19/00

(52) U.S. Cl. 521/56; 422/138; 425/470; 521/83

(57) ABSTRACT

A mobile polymer system. The system includes a mobile platform and a heat generating device mounted to the mobile platform. The system also includes a polymer expansion unit mounted to the mobile platform, wherein the polymer expansion unit is adapted to expand a polymer, using heat generated by the heat generating device, at a location of the mobile polymer expansion system to create an expanded polymer that can be used to create an expanded polymeric product that is comprised of the expanded polymer.

### BACKGROUND OF THE INVENTION

Expanded polymer foams such as those derived from expandable polystyrene (“EPS”) are used for a variety of products that have many uses. For example, expanded polymers are used as a component in lightweight concrete compositions, as molded products such as packing material, as forms used in building construction (e.g., insulated concrete forms, wall forms, deck forms, roof forms, etc.), etc. EPS is expanded by applying a heat source such as steam to the beads, allowing a blowing agent impregnated into the bead to expand the bead.

FIG. 1 illustrates a typical expanded polymer manufacturing and distribution system 10. In the system 10, a manufacturer 12 manufactures expandable polymer beads 13 which are transported to a molder 16, who pre-expands the thermoplastic particles which are then stored in some type of warehouse or collection area (e.g., a silo) 14. In response to customer orders, the expanded polymer is molded using an appropriate mold press and hot air, steam, hot water and/or electric heat. The finished product 20 is then transported to a location where it is put to its intended use.

The system 10 of FIG. 1 has the disadvantage in that the finished products made from the expanded polymer have a low density resulting in transportation being volume limited. In other words, the volume capacity of a vehicle is filled well before the weight carrying capacity is met. Thus, the finished products occupy a larger volume per weight than unexpanded polymer beads when transported to the end user 18. Such transportation costs are generally high because, due to volume constraints of the vehicle 16, only a small amount of finished product in terms of weight will fit into the cargo portion of the vehicle 16. The end result, is that the economically feasible range for distribution of many products made from expanded polymers is often limited because of the transportation costs involved in getting the products from the manufacturer to the customer.

Thus, there is a need for expanded polymer systems and methods that allow for products made from expanded polymers to be made available to customers in a manner that lessens the transportation penalty.

### SUMMARY OF THE INVENTION

In various embodiments, the present invention is directed to a mobile polymer system. The system includes a mobile platform and a heat generating device mounted to the mobile platform. The system also includes a polymer expansion unit mounted to the mobile platform, wherein the polymer expansion unit is adapted to expand a polymer, using heat generated by the heat generating device, at a location of the mobile polymer expansion system to create an expanded polymer that can be used to create an expanded polymeric product that is comprised of the expanded polymer.

In various embodiments, the present invention is directed to a method of producing an expanded polymeric product. The method includes generating heat from a heat generating device that is mounted to a mobile platform and expanding, with a polymer expansion unit mounted to the mobile platform, a polymer using heat generated by the heat generating device, at a location of the mobile platform, to create an expanded polymer that can be used to create the expanded polymeric product that is comprised of the expanded polymer.

In various embodiments, the present invention is directed to an expanded polymeric product. The product includes an expanded polymer, wherein the expanded polymer has been expanded from a polymer using a heat generating device that is mounted to a mobile platform and a polymer expansion unit that is mounted to the mobile platform.

In various embodiments, the present invention is directed to a mobile polymer expansion system. The system includes a mobile platform and heat generating means mounted to the mobile platform. The system also includes polymer expansion means mounted to the mobile platform, wherein the polymer expansion means is adapted to expand a polymer, using heat generated by the heat generating means, at a location of the mobile polymer expansion system to create an expanded polymer that can be used to create an expanded polymeric product that is comprised of the expanded polymer.

In various embodiments, the present invention is directed to a method of producing concrete. The method includes generating heat from a heat generating device that is mounted to a mobile platform and expanding, with a polymer expansion unit mounted to the mobile platform, a polymer using heat generated by the heat generating device, at a location of the mobile platform. The method also includes aging, from one hour to three days, the expanded polymer and adding the aged expanded polymer to a mixture comprising cement, water and an aggregate.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the invention. In such drawings:

FIG. 1 illustrates an embodiment of a typical expanded polymer manufacturing and distribution system;

FIG. 2 illustrates a mobile expanded polymer manufacturing and distribution system according to an embodiment of the present invention;

FIG. 3 illustrates a mobile expanded polymer manufacturing and distribution system according to another embodiment of the present invention;

FIG. 4 illustrates a mobile expanded polymer manufacturing and distribution system according to another embodiment of the present invention;

FIG. 5 illustrates a top plan view of a mobile expanded polymer processing system according to one embodiment of the present invention;

FIG. 6 illustrates a side elevation view of a mobile expanded polymer processing system according to another embodiment of the present invention;

FIG. 7 illustrates a top plan view of the mobile expanded polymer processing system of FIG. 6 according to one embodiment of the present invention;

FIG. 8 is a left side perspective view of the mobile expanded polymer processing system of FIG. 6 according to one embodiment of the present invention;

FIG. 9 is a right side perspective view of the mobile expanded polymer processing system of FIG. 6 according to one embodiment of the present invention; and

FIG. 10 is a perspective view of the mobile expanded polymer processing system of FIG. 6 with the sidewalls and the roof of the trailer in place.

### DESCRIPTION OF THE INVENTION

As used herein, the term “expanded polymer” means any type of thermoplastic particles such as, for example, expandable polystyrene (“EPS”), that have been impregnated with a blowing agent (e.g., pentane or carbon dioxide), and expanded to form a foam through the use of heat (e.g., steam).

As used herein, the term “heat generating device” refers to a machine that can apply sufficient heat to one or more thermoplastic particles to effect the expansion thereof and includes, but is not limited to steam generators, hot air generators, hot water boilers, or radiant heat devices that use, without limitation electricity, gasoline, diesel fuel, propane and/or natural gas for fuel.

As used herein, the term “expandable polystyrene” or “EPS” means a homopolymer of styrene impregnated with a blowing agent, and optionally containing additives, coatings, and/or lubricants to improve properties.

The expandable thermoplastic particles can be impregnated using any conventional method with a suitable blowing agent. Any gaseous material or material which will produce gases or evaporate sufficiently on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC's, which boil at a temperature below the softening point of the polymer chosen. Mixtures of these aliphatic hydrocarbon blowing agents can also be used. Alternatively, water can be blended with the aliphatic hydrocarbon blowing agents or water can be used as the sole blowing agent as taught in U.S. Pat. Nos. 6,127,439; 6,160,027; and 6,242,540. In these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The volatile blowing agent can be present at a level of less than 14 wt %, in some situations less than 6 wt %, in some cases ranging from about 2 wt % to about 5 wt %, and in other cases ranging from about 2.5 wt % to about 3.5 wt % based on the weight of the polymer.

In embodiments of the invention, the expandable thermoplastic particles can be foamed cellular polymer particles as taught in U.S. Patent Application Publication No. 2002-0117769 A1.

In other embodiments of the invention, the expandable thermoplastic particles can include an interpolymer of a polyolefin and in situ polymerized vinyl aromatic monomers that can be included in the expanded thermoplastic resin or polymer particles according to the invention is disclosed in U.S. Pat. Nos. 4,303,756, 4,303,757 and 6,908,949.

The expandable thermoplastic particles can include customary ingredients and additives, such as flame retardants, pigments, dyes, colorants, plasticizers, mold release agents, stabilizers, ultraviolet light absorbers, mold prevention agents, antioxidants, rodenticides, insect repellents, and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention the pigment is carbon black, a non-limiting example of such a material being EPS SILVER™, available from NOVA Chemicals Inc.

In another particular embodiment of the invention the pigment is graphite, a non-limiting example of such a material being NEOPOR®, available from BASF Aktiengesellschaft Corp., Ludwigshafen am Rhein, Germany.

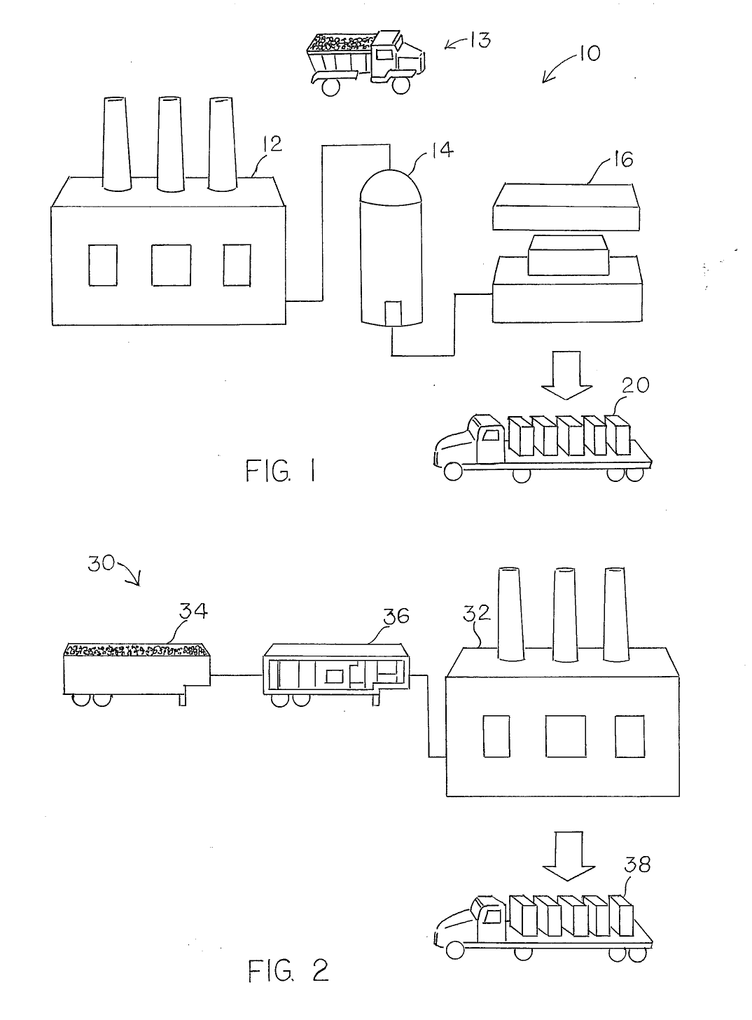

FIG. 2 illustrates a mobile expanded polymer manufacturing and distribution system 30 according to an embodiment of the present invention. As illustrated in FIG. 2, unexpanded polymer beads are transported to an end user facility 32 via a transport vehicle 34. A mobile expanded polymer processing system 36 is used to expand the polymer beads so that the end user facility 32 may create finished product 38, which can be transported for use by the customers of the end user facility 32. The end user facility 32 may have a storage facility that stores the expanded polymer or may use the expanded polymer to create the finished product 38 as the polymer is expanded by the mobile expanded polymer processing system 36. The expanded polymer may be aged for a period of time (e.g., from one hour to three days) prior to creating the finished product 38.

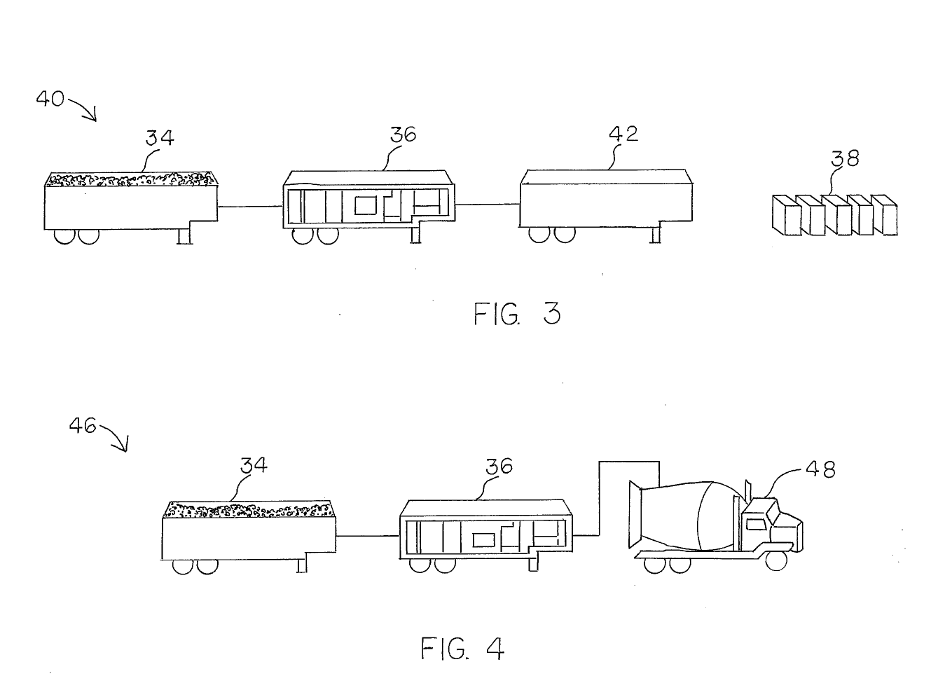

FIG. 3 illustrates a mobile expanded polymer manufacturing and distribution system 40 according to another embodiment of the present invention. In the system 40, the mobile expanded polymer processing system 36 creates expanded polymer from unexpanded polymer beads from the transport vehicle 34. A mobile processing facility 42 creates the finished product 38 from the expanded polymer at, for example, a site where the finished product 38 is to be used (e.g., a jobsite).

FIG. 4 illustrates a mobile expanded polymer manufacturing and distribution system 46 according to another embodiment of the present invention. In the system 46, the mobile expanded polymer processing system 36 creates expanded polymer from unexpanded polymer beads obtained from the transport vehicle 34. The expanded polymer may be added directly to a concrete mixer 48 to create a lightweight concrete composition such as that described in, for example, U.S. Patent Publication No. 2006/0225618 A1, which is owned by the assignee of the present invention.

In various embodiments, the expanded polymer is added to a mixture of cement, water and one or more aggregates to make the concrete. The aggregate may be any type of aggregate such as a fine aggregate (e.g., sand) and/or a coarse aggregate (e.g., gravel). The mixture may also include admixtures, fibers, etc. An exemplary concrete composition contains from 10 to 90 volume percent of a cement composition, from 10 to 90 volume percent of expanded polymer particles having an average particle diameter of from 0.2 mm to 8 mm, a bulk density of from 0.03 g/cc to 0.64 g/cc, an aspect ratio of from 1 to 3, and from 0 to 50 volume percent of aggregate, where the sum components used does not exceed 100 volume percent. Also, the mixture may have a compressive strength of at least 1700 psi as tested according to ASTM C39 after seven days. Concrete compositions according to various embodiments of the present invention may be used to make, for example, concrete masonry units, construction panels, road beds, etc. In one embodiment, the expanded polymer is aged (e.g., from 1 hour to 3 days) at a concrete manufacturing facility.

The transport vehicle 34 may be, for example, a truck or trailer, a rail car, a marine vessel, an aircraft, etc. In various embodiments, the transport vehicle 34 and the mobile polymer processing system 36 may be combined into one unit that performs the function of the transport vehicle 34 and the mobile expanded polymer processing system 36. In various embodiments, the function of the transport vehicle 34 and the mobile expanded polymer processing system 36 may be accomplished using any number of vehicles or platforms. In various embodiments, the finished product 38 may be, for example, building products, packaging products, lightweight additives for mixtures such as concrete, construction forms such as insulated concrete forms, wall forms, deck forms, roof forms, etc., shipping pallets, and other block and shape molding applications.

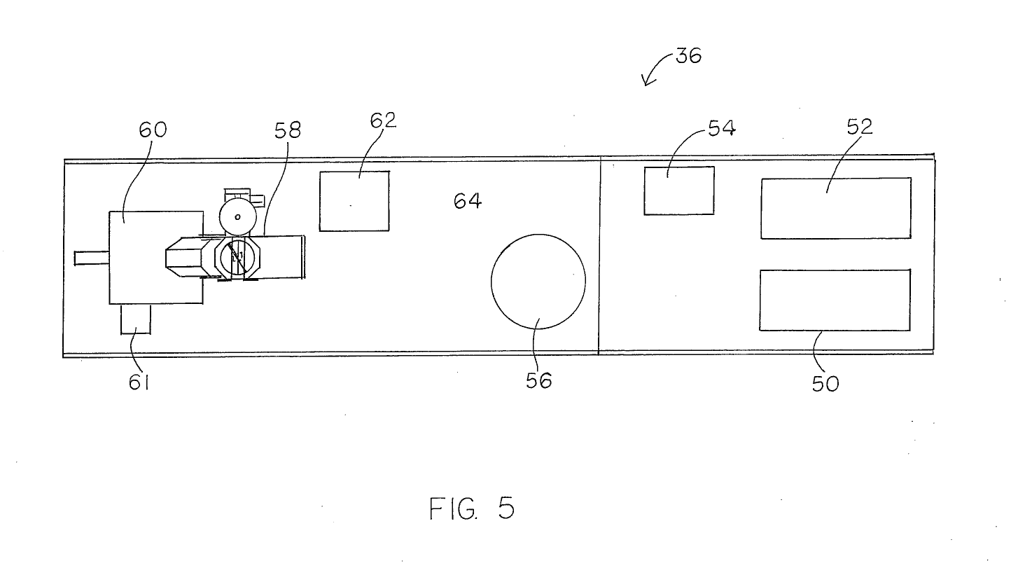

FIG. 5 illustrates a top plan view of the mobile expanded polymer processing system 36 according to one embodiment of the present invention. The system 36 includes the various elements that are needed to expand polymer for use in various applications. The system 36 includes an electric generator 50 that generates electricity for operation of the various components of the system 36. The system 36 also includes an air compressor 52 that provides compressed air that is used in the polymer expansion operation. A heat generating device, such as a steam boiler 54 uses water from a water tank 56 to generate steam for use in the expansion operation. The steam boiler 54 may be, for example, an electric boiler, a natural gas-fired boiler, a propane-fired boiler, a gasoline-fired boiler, a diesel fuel-fired boiler, a coal-fired boiler, a wood-fired boiler, etc. A pre-expander unit 58 expands the polymer, which is expelled in its expanded form into a take away hopper 60 using a take away blower 61. The pre-expander unit 58 may be, for example, a continuous pre-expander, a batch pre-expander, etc. A control panel 62 controls the expansion operation that is performed by the pre-expander unit 58.

The various components 50, 52, 54, 56, 58, 60, 61 and 62 of the system 36 are mounted on a portable platform 64. The portable platform 64 may be any type of land, sea or air vehicle such as, for example, a trailer, a rail car, a ship, a barge, a wagon, an aircraft (e.g., a fixed wing aircraft, a helicopter, etc.), etc. The various components 50, 52, 54, 56, 58, 60, 61 and 62 of the system 36 may be mounted to the portable platform 64 using any type of temporary or permanent mounting methods or devices.

In an exemplary embodiment that, the electric generator 50 is 300 Kw 277/480 Volt 3 ph diesel generator, the air compressor 52 is a 15 HP rotary screw air compressor of the type manufactured by Ingersoll Rand, the steam boiler 54 is an electric steam boiler of the type manufactured by Sussman, the water tank 56 is a 750 gallon water tank, and the pre-expander unit 58 is a continuous pre-expander of the type manufactured by Tri Technologies, Inc. Also, in an exemplary embodiment, the portable platform 64 is a forty-foot trailer of the type manufactured by Kentucky Trailer.

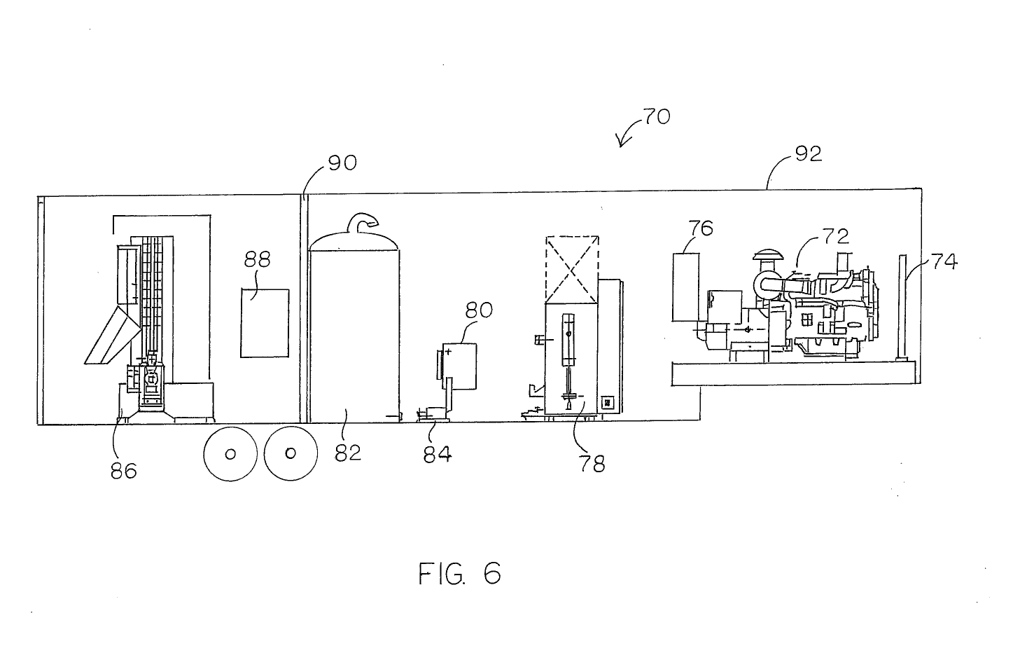

FIG. 6 illustrates a side elevation view of a mobile expanded polymer processing platform 70 according to another embodiment of the present invention. The platform 70 includes a generator 72 that has a cooling fan 74 and a motor control center 76. The platform 70 also includes a boiler 78 that is connected to a blowdown separator tank 80. The platform 70 further includes a water tank 82 that is connected to a feed water pump 84 that is used to fill the water tank 82 when the pump 84 is connected to a water source. A pre-expander 86 on the platform 70 is controlled by a control panel 88. The platform 70 includes a dividing partition 90 that separates a portion of the platform 70 on which the pre-expander 86 is mounted from a portion of the platform 70 on which the other components are mounted. In the embodiment illustrated in FIG. 6, the components of the platform 70 are mounted on a trailer 92.

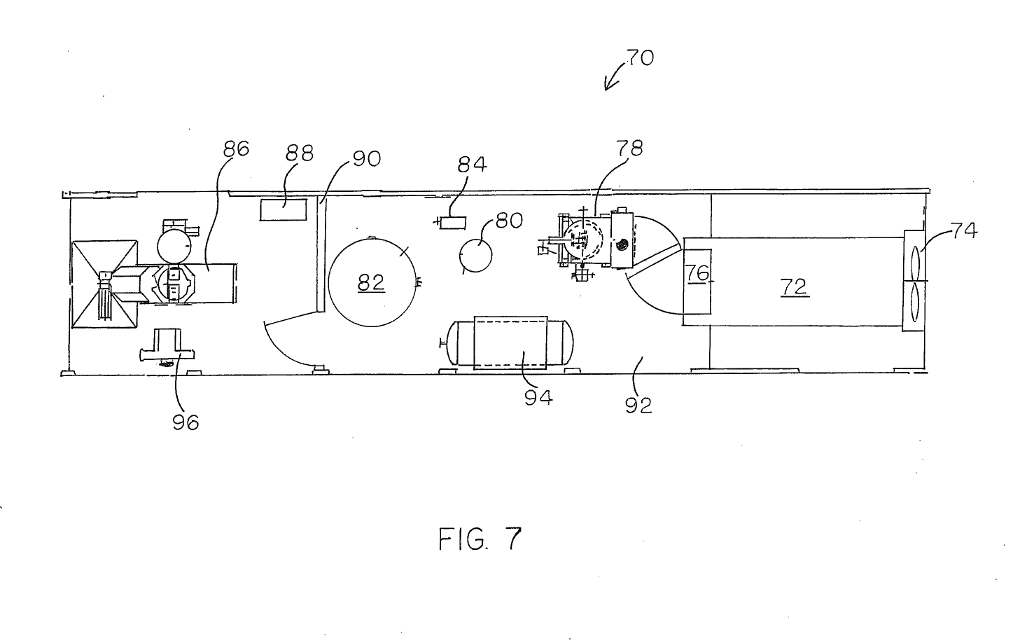

FIG. 7 illustrates a top plan view of the mobile expanded polymer processing platform 70 of FIG. 6 according to one embodiment of the present invention. As illustrated in FIG. 7, the platform 70 includes an air compressor 94. Also, the platform includes a blower 96 that is connected to the pre-expander 86.

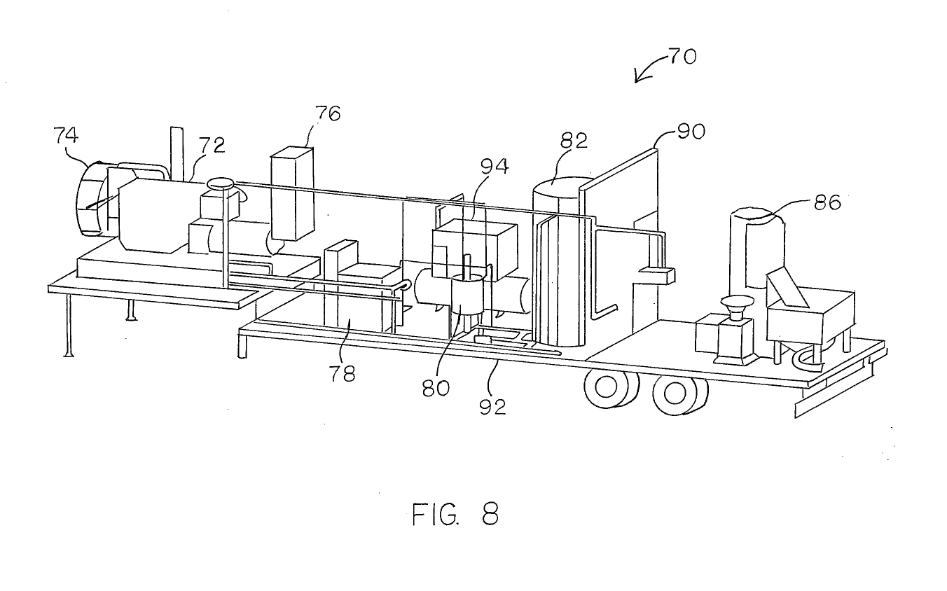

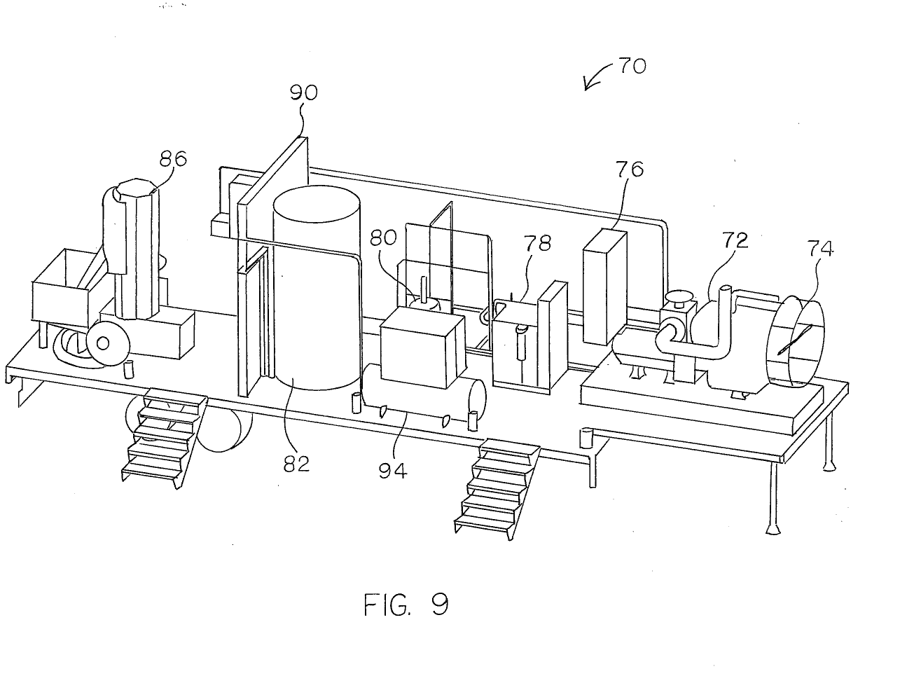

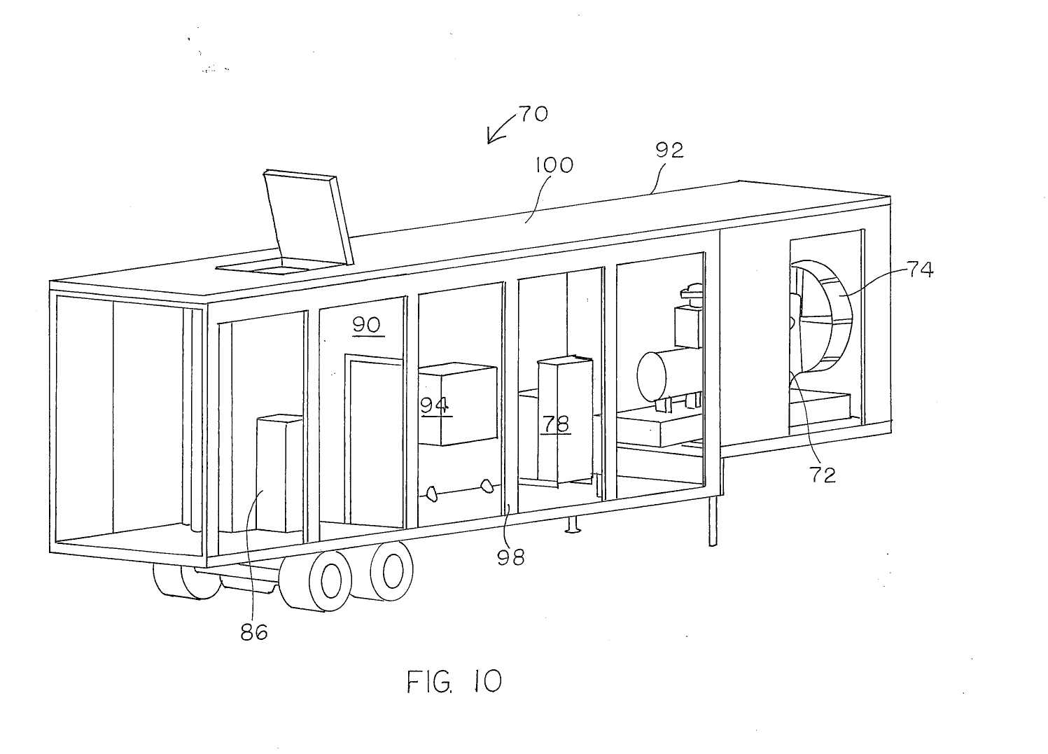

FIG. 8 is a left side perspective view of the mobile expanded polymer processing platform 70 of FIG. 6 according to one embodiment of the present invention and FIG. 9 is a right side perspective view of the mobile expanded polymer processing platform 70 of FIG. 6 according to one embodiment of the present invention. As shown in FIGS. 8 and 9, the sides of the trailer 92 have been removed so that the components of the platform 70 may be more easily viewed. FIG. 10 is a perspective view of the mobile expanded polymer processing platform 70 of FIG. 6 with sidewalls 98 and roof 100 of the trailer 92 in place.

It can be understood that the physical locations of the components of the mobile systems described herein are illustrative only and the components may have any physical arrangement that may be desired without departing from the scope of the embodiments of the present invention. Also, it can be understood that certain components may be added for operation of the systems described herein. An example of such a component is a hydrocarbon capturing device that is configured to capture and optionally incinerate hydrocarbon emissions created as a by-product of the polymer expansion processes described herein.

The expansion of the expandable thermoplastic particles is conventionally carried out by heating the particles via any conventional heating medium, such as steam, hot air, hot water, or radiant heat. One generally accepted method for accomplishing the pre-expansion of impregnated thermoplastic particles is taught in U.S. Pat. No. 3,023,175.

The expandable thermoplastic particles can be expanded to a bulk density of at least 0.75 lb/ft³ (0.012 g/cc), in some instances 1 lb/ft³ (0.016 g/cc), in other instances at least 1.25 lb/ft³ (0.02 g/cc), in some cases 1.75 lb/ft³ (0.028 g/cc), in some circumstances at least 2 lb/ft³ (0.032 g/cc), in other circumstances at least 3 lb/ft³ (0.048 g/cc) and in particular circumstances at least 3.25 lb/ft³ (0.052 g/cc) or 3.5 lb/ft³ (0.056 g/cc). In other situations, the expandable thermoplastic particles are at least partially expanded and the bulk density can be up to 35 lb/ft³ (0.56 g/cc), in some cases up to 30 lb/ft³ (0.48 g/cc), in other cases up to 25 lb/ft³ (0.4 g/cc), in some instances up to 20 lb/ft³ (0.32 g/cc), in other instances up to 15 lb/ft³ (0.24 g/cc) and in certain circumstances up to 10 lb/ft³ (0.16 g/cc). The bulk density of the expanded polymer particles can be any value or range between any of the values recited above. The bulk density of the expanded polymer particles is determined by weighing a known volume of polymer particles, beads and/or prepuff particles (aged 24 hours at ambient conditions).

The expanded polymer particles can have an average particle size of at least 0.2, in some circumstances at least 0.3, in other circumstances at least 0.5, in some cases at least 0.75, in other cases at least 0.9 and in some instances at least 1 mm and can be up to 8, in some circumstances up to 6, in other circumstances up to 5, in some cases up to 4, in other cases up to 3, and in some instances up to 2.5 mm. The average particle size of the expanded polymer particles can be any value and can range between any of the values recited above. The average particle size of the expanded polymer particles can be determined using laser diffraction techniques or by screening according to mesh size using mechanical separation methods well known in the art.

The present invention has been described with reference to specific details of particular embodiments thereof. It is not intended that such details be regarded as limitations upon the scope of the invention except insofar as and to the extent that they are included in the accompanying claims.

What is claimed is:

1. A mobile polymer system, comprising:
a mobile platform;
a heat generating device mounted to the mobile platform; and
a polymer expansion unit mounted to the mobile platform, wherein the polymer expansion unit is adapted to expand a polymer, using heat generated by the heat generating device, at a location of the mobile polymer expansion system to create an expanded polymer that can be used to create an expanded polymeric product that is comprised of the expanded polymer.

2. The system of claim 1, further comprising an electrical generator mounted to the mobile platform.

3. The system of claim 1, wherein the mobile platform is one of a vehicle, a trailer, a rail car, a ship, a barge, a wagon and an aircraft.

4. The system of claim 1, further comprising a processing facility that is adapted to create the expanded polymeric product.

5. The system of claim 4, wherein the processing facility is a molding machine.

6. The system of claim 1, further comprising a water tank mounted to the mobile platform.

7. The system of claim 1, wherein the expanded polymeric product is one of a partially expanded polymer bead, a building product, a packaging product, a lightweight additive to a mixture, a shipping pallet and a construction form.

8. The system of claim 1, wherein the polymer expansion unit is one of a continuous pre-expander and a batch pre-expander.

9. The system of claim 1, wherein the heat generating device includes one of a hot air generator, a hot water boiler, and a radiant heat device.

10. The system of claim 1, wherein the heat generating device includes a steam generation device.

11. The system of claim 10, wherein the steam generation device is one of an electric boiler, a natural gas-fired boiler, a propane-fired boiler, a gasoline-fired boiler, a diesel fuel-fired boiler, a coal-fired boiler and a wood-fired boiler.

12. The system of claim 1, further comprising an air compressor mounted to the mobile platform.

13. The system of claim 1, further comprising a device for capturing hydrocarbon emissions.

14. The system of claim 1, wherein the polymer expansion unit is adapted to expand polystyrene.

15. A method of producing an expanded polymeric product, the method comprising:
generating heat from a heat generating device that is mounted to a mobile platform; and
expanding, with a polymer expansion unit mounted to the mobile platform, a polymer using heat generated by the heat generating device, at a location of the mobile platform, to create an expanded polymer that can be used to create the expanded polymeric product that is comprised of the expanded polymer.

16. The method of claim 15, wherein the polymer is impregnated with a blowing agent.

17. The method of claim 15, wherein the expanded polymer is aged for from 1 hour to 3 days prior to being used to create the expanded polymeric product.

18. The method of claim 15, further comprising adding an additive to the polymer.

19. The method of claim 15, wherein the polymer comprises a pigment.

20. An expanded polymeric product, comprising:
an expanded polymer, wherein the expanded polymer has been expanded from a polymer using a heat generating device that is mounted to a mobile platform and a polymer expansion unit that is mounted to the mobile platform.

21. The product of claim 20, wherein the product is one of a partially expanded polymer bead, a building product, a packaging product, a lightweight additive to a mixture, a shipping pallet and a construction form.

22. A mobile polymer expansion system, comprising:
a mobile platform;
heat generating means mounted to the mobile platform; and
polymer expansion means mounted to the mobile platform, wherein the polymer expansion means is adapted to expand a polymer, using heat generated by the heat generating means, at a location of the mobile polymer expansion system to create an expanded polymer that can be used to create an expanded polymeric product that is comprised of the expanded polymer.

23. A method of producing concrete, the method comprising:
generating heat from a heat generating device that is mounted to a mobile platform;
expanding, with a polymer expansion unit mounted to the mobile platform, a polymer using heat generated by the heat generating device, at a location of the mobile platform;
aging, from one hour to three days, the expanded polymer; and
adding the aged expanded polymer to a mixture comprising cement, water and an aggregate.

24. The method of claim 23, wherein the aggregate is one of a fine aggregate and a coarse aggregate.

25. The method of claim 23, wherein the polymer is expanded and aged at a concrete manufacturing facility.
